(19) United States
(12) Patent Application Publication
(10) Pub. No.: US 2019/0297841 A1
(43) Pub. Date: Oct. 3, 2019

(54) Gravity Feeder With Weighted Ball

(71) Applicant: Caleb Smith, Oklahoma City, OK (US)

(72) Inventor: Caleb Smith, Oklahoma City, OK (US)

(21) Appl. No.: 16/443,157

(22) Filed: Jun. 17, 2019

Related U.S. Application Data
(63) Continuation-in-part of application No. 15/926,396, filed on Mar. 20, 2018.

(51) Int. Cl. A01K 5/02

(52) U.S. Cl. CPC A01K 5/0225

(57) ABSTRACT

A gravity feeder with a weighted ball includes a hopper having a conical configuration that may be hung from a tree branch. The hopper includes a funnel shaped configuration and defines an open top into which granular feed may be deposited into an interior area of the hopper. A plurality of tubular distribution sections extends from a mouth of the hopper to near the ground for depositing the feed thereon. The gravity feeder includes a heavy spherical ball situated atop the feed in the hopper that pushes the feed downward into the conduit and, in fact, can descend into the distribution sections to ensure the feed is completely deposited.

### REFERENCE TO RELATED APPLICATIONS

This application is a continuation-in-part and claims the benefit of patent application U.S. Ser. No. 15/926,396 filed Mar. 20, 2018 titled Gravity Feeder with Weighted Ball and which is incorporated herein by reference.

### BACKGROUND OF THE INVENTION

This invention relates generally to animal feeding devices and, more particularly, to a gravity feeder having a weighted ball to force the complete deposit of granular or powdered feed onto the ground.

Gravity feeders are devices for dispensing granular or powder food material to livestock. Such feeders are known to suffer from incomplete emptying or even become clogged as the feed material may become wet or simply be clumpy from the start. To overcome this problem, some gravity feeders have utilized electric powered agitators to break up the clumps. Other attempts have also fallen short of the objects of the present invention.

For instance, U.S. Pat. No. 4,554,888 to Gross discloses an animal feeder trough having a sleeve that may be slidably coupled or movable relative to the bottom of the feed delivery tube so that the size of a feed pile may be increased or decreased. Only when the adjustable sleeve is positioned below the bottom of the delivery tube does it have a diameter larger than a diameter of delivery tube. At all other times, such as when moved upwardly to increase the size of the feed pile, the diameter of the delivery tube sections always has the same diameter. This disadvantage taught by Gross is remedied by the present invention which includes a lowermost distribution section having an upper portion coupled to a next lowermost distribution section and a lower portion fixedly attached (not slidably adjustable) to the upper portion with a diameter that is larger than a diameter of any upwardly situated distribution section. The specific configuration disclosed by the present invention allows for lateral expansion of feed and inhibits clogging.

In addition, US Patent publication 2012/0216749 to Brumbaugh and US Patent publication 2006/0137617 to Leombruno disclose animal feeders having a ball feature. Contrary to the objects and disclosure of the present invention, however, the aforesaid patents teach use of a ball to stop feed from flowing or to selectively seal the open bottom of a delivery trough. More particularly, Leombruno specifically discloses in FIG. 1 and paragraph 35 that a “stopper ball” may be positioned to prevent feed from flowing into the trough. Further, Brumbaugh teaches an actuator positioned in the discharge tube for regulating feed flow (as seen in claims 11-13 and paragraph [0041] et seq.)) By contrast, the present invention teaches a weighted ball specifically positioned to push down upon or force feed from a hopper into a plurality of delivery sections, and out of an outlet opening onto the ground—the weighted ball itself falling to the ground.

Although presumably effective for their desired purposes, the existing products and proposals require external or battery power which may not be available in remote areas or simply be cost prohibitive. In addition, the existing products and proposals do not prevent clogging and may, in fact, include teaching a ball or actuator intent on stopping the flow of feed rather than forcing or pushing it into delivery sections and outward of an outlet.

Therefore, it would be desirable to have a gravity feeder with weighted ball that may be hung from a tree branch so as to move in the wind, the gravity feeder including a conical hopper having an open top into which granular feed may be deposited and having a plurality of distribution sections extending from a mouth of the hopper to near the ground for depositing the feed thereon. Further, it would be desirable to have a gravity feeder that includes a heavy ball situated atop the feed in the hopper that pushes the feed downward into the conduit and, in fact, can descend into the conduit to ensure the feed is completely deposited.

### SUMMARY OF THE INVENTION

A gravity feeder apparatus according to the present invention includes a hopper having a continuous side wall having a conical configuration, the continuous side wall having a rim at an upper end thereof and having a mouth at a lower end. The continuous side wall defines an interior area for holding the granular feed. A plurality of distribution sections is operably coupled to the mouth, each distribution section having a tubular configuration having an open top and an open bottom that allows the granular feed to pass therethrough. A spherical weight or weighted ball is positioned atop the granular feed in the hopper, the spherical weight pushing the granular feed downward from the hopper into the plurality of distribution sections and out through the open bottom or outlet opening.

Therefore, a general object of this invention is to provide a gravity feeder having a hopper for receiving granular feed and having a spherical weight situated atop the granular feed to ensure complete deposit of the granular feed.

Another object of this invention is to provide a gravity feeder, as aforesaid, that may be hung from a tree branch so that a hopper with granular feed may swing freely in the breeze and, thus, spread out deposited feed.

Still another object of this invention is to provide a gravity feeder, as aforesaid, having a plurality of modular distribution sections that may be fastened to a mouth of the hopper so as to be length adjustable relative to the height of mounting to a tree branch.

Yet another object of this invention is to provide a gravity feeder, as aforesaid, having a lowermost delivery section defining a diameter larger than any preceding delivery section so as prevent clogging and to promote full dispensing of feed.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a gravity feeder with weighted ball according to a preferred embodiment of the present invention;

FIG. 2 is an exploded view of the gravity feeder with weighted ball as in FIG. 1;

FIG. 3 is an isolated view of a hopper according to the present invention illustrated with the lid removed;

FIG. 4 is a top view of the hopper as in FIG. 3;

FIG. 5a is a side view of a distribution section taken from FIG. 1;

FIG. 5b is a sectional view taken along line 5b-5b of FIG. 5a;

FIG. 6a is a side view of an outlet section taken from FIG. 1;

FIG. 6b is a sectional view taken along line 6b-6b of FIG. 6a;

FIG. 7 is an isolated view on an enlarged scale of the weighted ball as in FIG. 2.

FIG. 8 is a perspective view of a gravity feeder according to another embodiment of the present invention, illustrated in an imaginary transparent condition so as to better show the flow of feed therethrough and shown with a lid in a separated condition;

FIG. 9 is another perspective view of the gravity feeder as in FIG. 8, illustrated with the feed completely pushed out of the reservoir and dispensing tube;

FIG. 10 is another perspective view of the gravity feeder as in FIG. 8, illustrating the feed partially pushed out of the dispensing tube;

FIG. 11 is another perspective view of the gravity feeder as in FIG. 8;

FIG. 12A is an exploded view of the gravity feeder as in FIG. 8;

FIG. 12B is an isolated view on an enlarged scale taken from FIG. 12A; and

FIG. 13 is a side view of the gravity feeder as in FIG. 8, illustrated with the lid removed and exemplary dimensions shown.

### DESCRIPTION OF THE PREFERRED EMBODIMENT

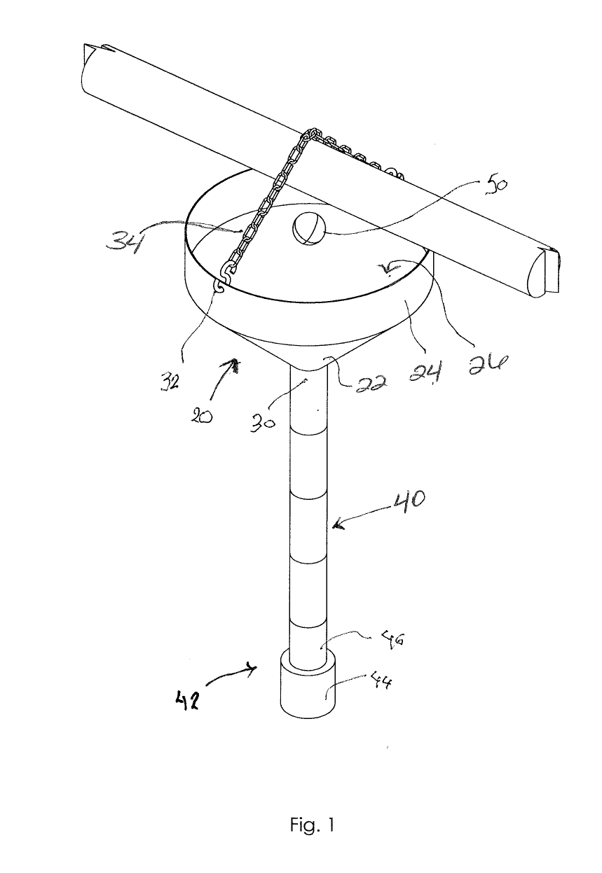

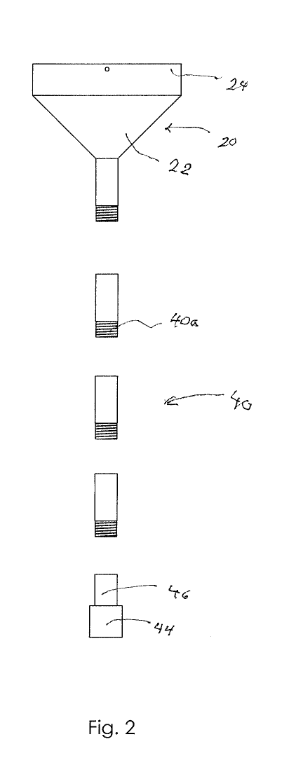

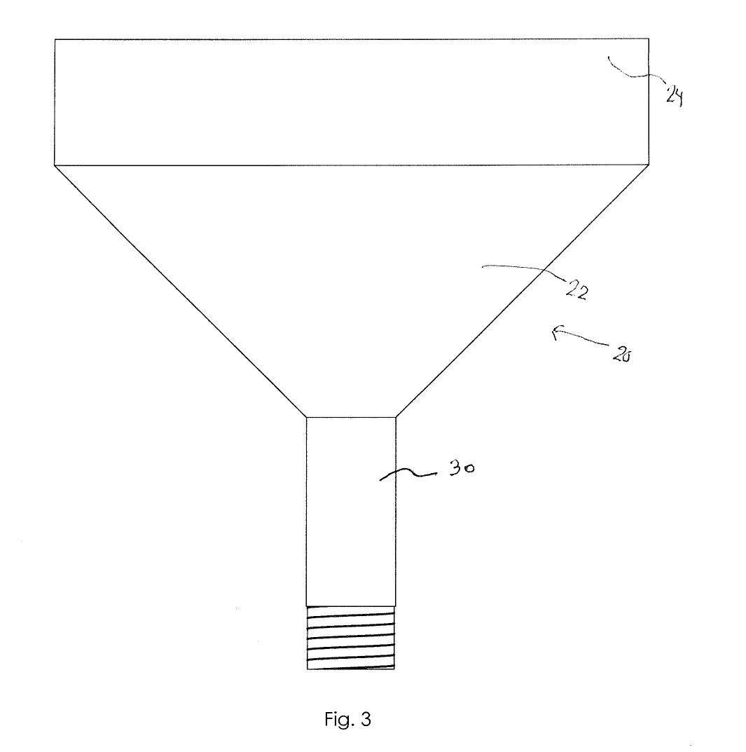

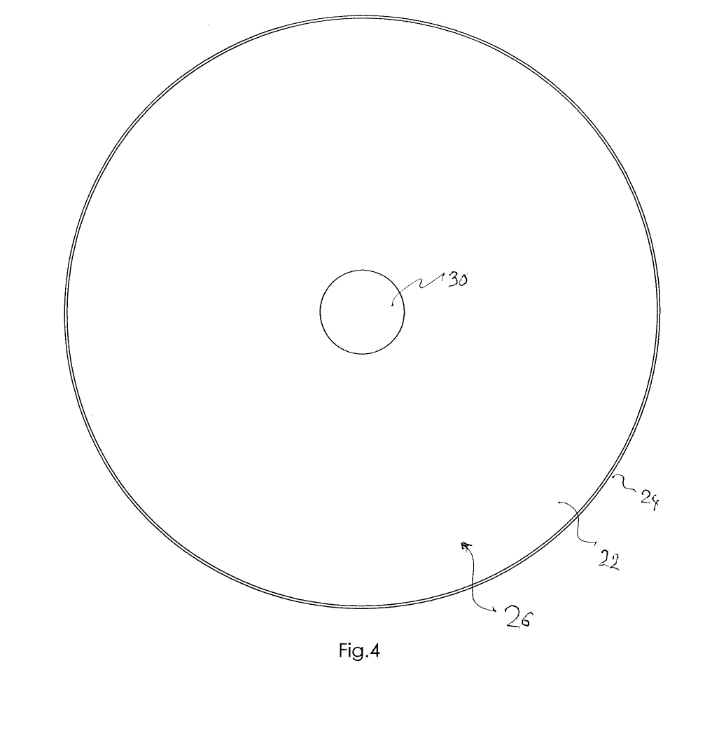

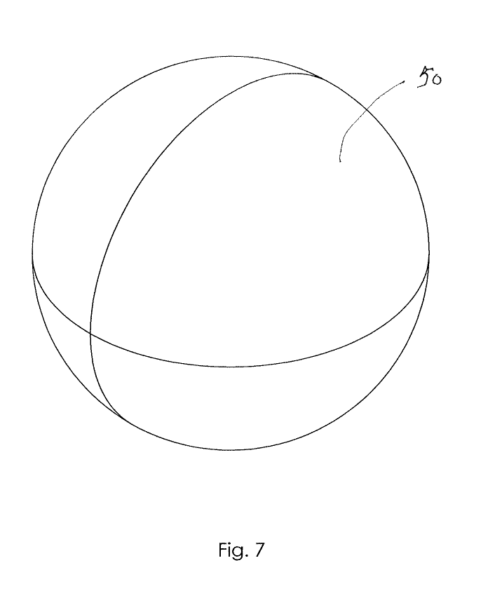

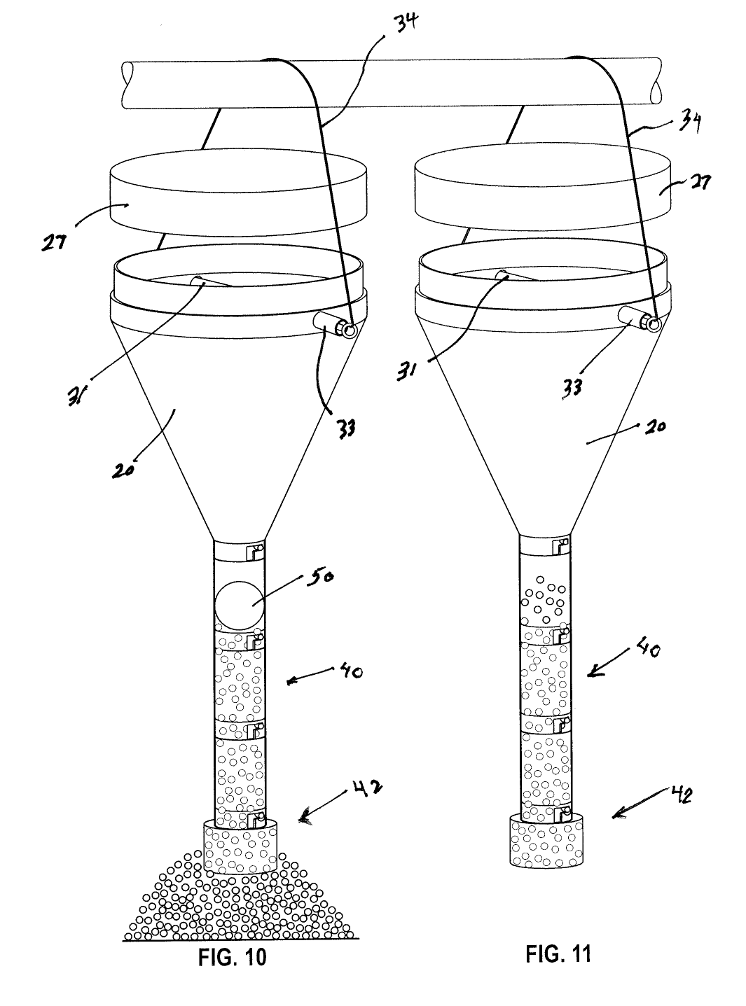

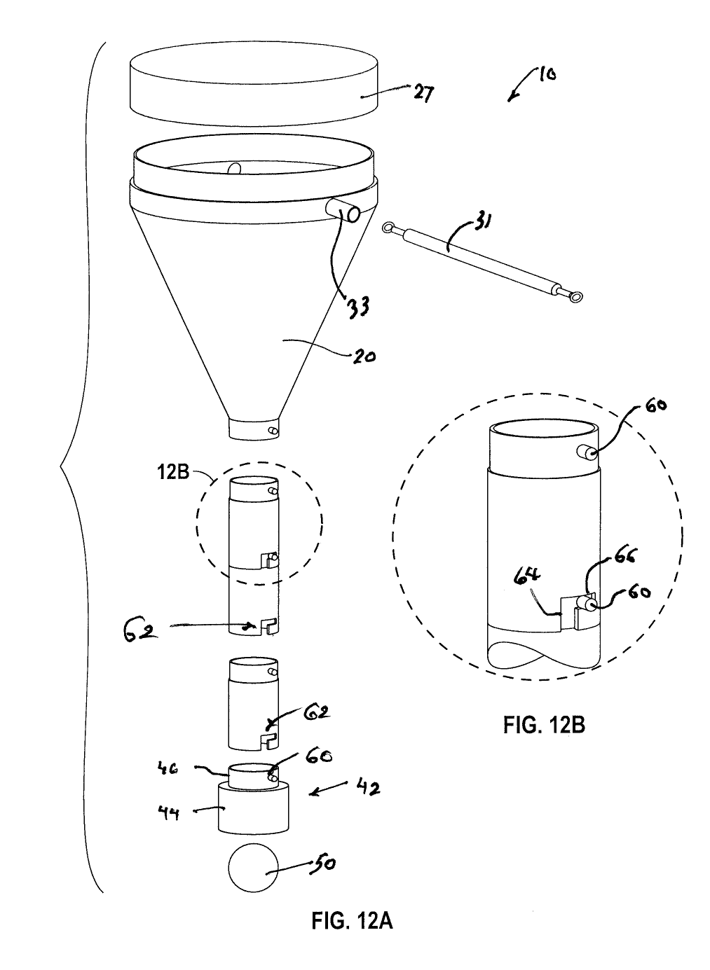

A gravity feeder with weighted ball according to a preferred embodiment of the present invention will now be described in detail with reference to FIGS. 1 to 13 of the accompanying drawings. The gravity feeder 10 with weighted ball includes a hopper 20, a plurality of modular distribution sections 40, and a weighted ball 50.

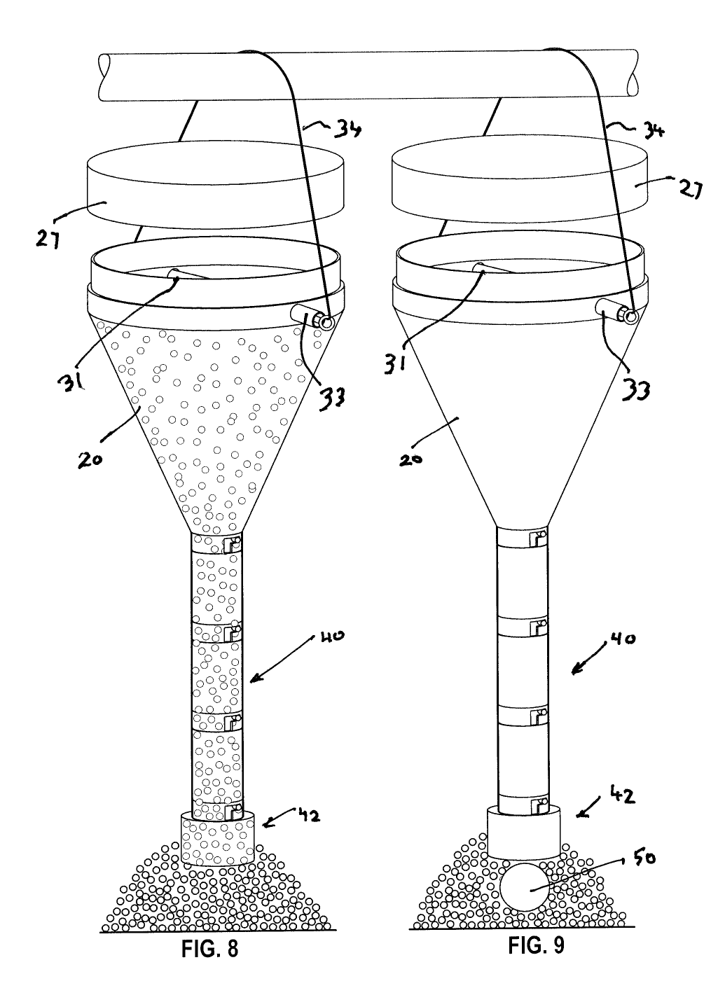

The hopper 20 includes a continuous side wall 22 having a generally conical or funnel shaped configuration, the hopper 20 defining an interior area and includes an upper rim 24 defining an open top 26 giving access to the interior area of the hopper 20. The hopper 20 includes lower mouth 30 that is open. A lid 27 (FIGS. 8 and 9) may be selectively mounted atop rim 24 for regulating when the interior area of the hopper 20 may be accessed, such as to insert granular or powdered feed into the hopper 20 or to protect from weather elements such ad rain or snow. In an embodiment, the lid 27 and upper rim 24 may have complementary thread patterns for a threaded engagement although other fasteners would also work.

In an embodiment, a pair of fasteners 32 may be coupled to the rim 24 of the hopper 20 (FIG. 1). Alternatively, a pair of extension arms (not shown) extend laterally in opposite directions from an exterior of the side wall of the hopper 20. Then, a mooring member 34, such as a chain or sturdy rope, may be coupled to free ends of the fasteners 32 for securing the hopper 20 to a branch of a tree. It is understood that by hanging from a tree branch, the hopper 20 is free to move side to side and even rotate reciprocally by the natural forces of the wind or as the apparatus is nudged by livestock.

According to another embodiment and as shown in FIGS. 8 to 12, the pair of fasteners is identified with reference numeral 33 and they are operably coupled to the rim 24 of the hopper 20, each fastener having a tubular configuration and defining a channel through which the support bar 31 may extend. Alternatively, a pair of extension arms (not shown) may extend laterally in opposite directions from an exterior of the side wall of the hopper 20. Then, a mooring member 34, such as a chain or sturdy rope, may be coupled to free ends of the support bar 31 for securing the hopper 20 to a branch of a tree. It is understood that by hanging from a tree branch, the hopper 20 is free to move side to side and even rotate reciprocally by the natural forces of the wind or as the apparatus is nudged by livestock. It is preferred that the lowest conduit of the plurality of distribution sections will open very close to the ground so that the feed will stop itself as it piles against the ground (as shown in FIGS. 8-10).

The pair of fasteners 33 defines a pair of opposed holes, respectively, and the gravity feeder 10 may include a support bar 31 extending through respective opposed holes. In an embodiment, the rim 24 itself may define a pair of opposed holes through which the support bar 31 may pass. More particularly, the support bar 31 extends across the diameter of the hopper 20 adjacent the open top 26. It is understood that the support bar 31 is important to maintaining the integrity of the upper rim 24 (i.e. will not warp) so that the lid 27 will fit properly. In addition, ends of the support bar 31 includes flanges to which ends of the mooring member 34 may be coupled (FIG. 8) as described above.

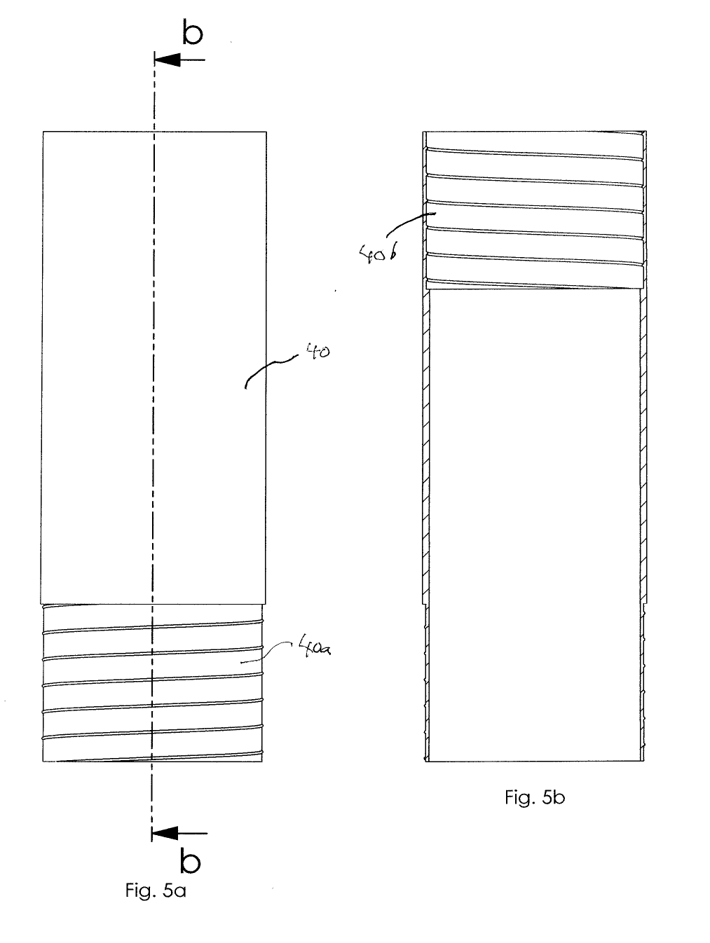

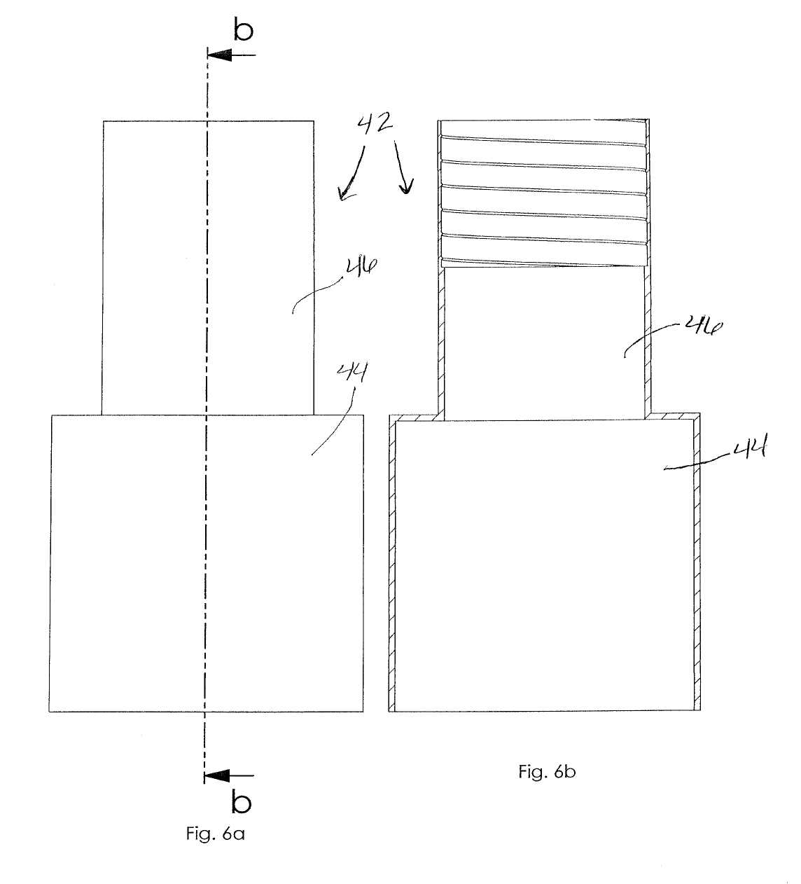

In the embodiment shown in FIGS. 1 to 7, the plurality of distribution sections 40 and specifically an uppermost distribution section, is attached to the mouth 30 of the hopper 20, in an embodiment, by a threaded friction fit (FIGS. 5a and 5b). It is understood that each distribution section 40 may include both an outwardly threaded section 40a and an inwardly threaded section 40b such that the plurality of distribution sections is modular and each may be coupled to a next section. The number of distribution sections 40 may be varied according to how high the branch is, i.e. how far the hopper 20 is situated above the ground. It is preferred that the lowest conduit of the plurality of distribution sections will open very close to the ground so that the feed will stop itself as it piles against the ground (as shown in FIGS. 8-10). The lowermost distribution section 42 may also be referred to as an outlet section and has a slightly different configuration (FIGS. 6a and 6b). The outlet section 42 may include an upper portion 46 for attachment to an upwardly adjacent distribution section and a lower portion 44 fixedly attached to the upper portion 46 and having a diameter that is larger than a diameter of all other distribution sections so as to deposit granular feed more readily or over a larger surface area of the ground. The larger diameter of the outlet section also enables the feed to be expanded laterally, especially if experiencing increased moisture content and so as not to become clogged at the bottom of the delivery sections 40. The lower portion 44 is not movable or adjustable relative to the upper portion 46. In an embodiment, the upper portion 46 may have diameter of about 6.5″ while the lower portion 44 may have a diameter of about 9.5″—more than just a coincidental width of the wall thickness of the lower portion coupled to the upper portion as in the prior art.

In another embodiment shown in FIGS. 8 to 12, the plurality of distribution sections 40 has an alternative means for attachment to one another (other than the complementary threads 40a, 40b shown in FIGS. 5a and 5b). More particularly, each distribution section 40 has a tubular side wall that includes an upper end having a locking prong 60 that extends away from the side wall. The distribution section 40 also includes a lower end defining a locking slot 62 operable and configured to receive a locking prong 60. More particularly, each locking slot 62 includes a first void section 64 extending longitudinally along the side wall and in communication with an open bottom of the distribution section 40 and includes a second void section 66 extending laterally from and in communication with the first void section 64. Stated simply, each locking slot 40 has an L-shaped configuration in which a locking prong 60 may be first received into a first void section 64 and then, when two adjacent distribution sections 40 being coupled together are rotated (such as in a contrary or counter-rotating manner), received into an associated second void section 66 in a releasably locking arrangement. Attachment of additional distribution sections 40 in this embodiment is faster and easier than in other embodiment or existing or past manner.

In a critical aspect and to avoid the inherent clogging of existing gravity feeders or incomplete deposition of the granular feed material, the present invention includes a spherical weight or, as will commonly be referred to as a weighted ball 50. The weighted ball 50 has a diameter that is large enough and a weight heavy enough to effectively push the granular feed into the mouth 30 and into a plurality of distribution sections 40, especially as the hopper 20 is turned by the wind or nudged by livestock. Movement of the weighted ball 50 is best shown in FIGS. 8 to 10. The weighted ball 50 may have a diameter that allows it to descend into the distribution sections 40 in order to push the feed all the way through the outlet section. An exemplary diameter of the ball is 4.5 inches. To be clear, it is intended that the weighted ball 50 will actually fall through the open bottom of the lowermost distribution section and to the ground only after pushing all of the granular feed out through the same open bottom. The weighted ball 50 may then be retrieved by a user and placed atop the granular feed the next time the hopper 20 is filled.

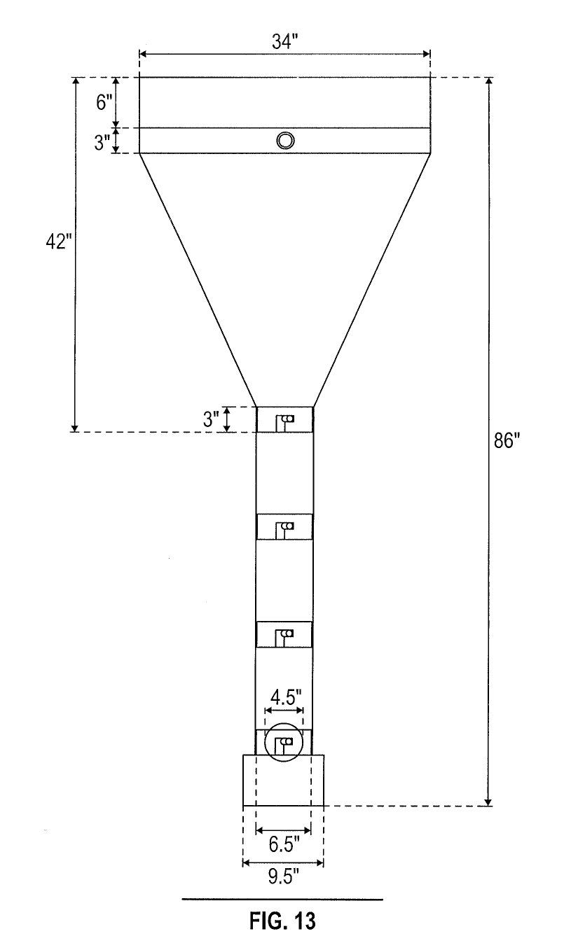

FIG. 13 illustrates exemplary dimensions for an efficient gravity feeder 10. As shown, each distribution section 40 has an exemplary diameter of 6.5″ while the weighted ball 50 has an exemplary diameter of 4.5″ as described. Then, the lower portion 44 of the outlet section 42 has a larger diameter, such as 9.5″, so that granular or powdered feed does not become clogged and, in fact, is dispensed in an efficient trapezoidal pile for feeding animals. It is understood that the exemplary dimensions are functional reasons why applicant believes the present invention works efficiently and are not mere design choices of a manufacturer.

It is understood that while certain forms of this invention have been illustrated and described, it is not limited thereto except insofar as such limitations are included in the following claims and allowable functional equivalents thereof.

1. A gravity feeder apparatus for feeding granular feed to animals, comprising:
a hopper having a continuous side wall having a conical configuration, said continuous side wall having a rim at an upper end thereof defining an open top and having a mouth at a lower end that defines an open bottom;
wherein said continuous side wall defines an interior area for holding the granular feed inserted via said open top;
wherein said rim has a diameter that is larger than a diameter of said mouth such that said continuous side wall has a funnel-shaped configuration;
a plurality of distribution sections operably coupled to said mouth, each distribution section having a tubular configuration having an open top and an open bottom that allows the granular feed to pass therethrough; and
a weight having a spherical configuration initially positioned atop the granular feed in said hopper, said spherical weight having a dimension and weight operable for pushing the granular feed downward from said hopper into said plurality of distribution sections, said spherical weight being movable to pass through said mouth of said hopper and, after pushing all of the granular feed, through said open bottom of respective distribution sections.

2. The gravity feeder apparatus as in claim 1, wherein each of said plurality of distribution sections includes:
an uppermost section coupled to said mouth of said hopper;
a lowermost section having an upper portion coupled to an upwardly adjacent distribution section and a lower portion having a diameter that is larger than a diameter of all other sections of said plurality of distribution section so that the granular feed is more widely distributed on a ground surface;
a plurality of intermediate sections coupled between said uppermost section and said lowermost section;
a tubular conduit for transferring the granular material from said hopper to the ground.

3. The gravity feeder apparatus as in claim 3, wherein each distribution section of said plurality of distribution sections includes:
an upper end having a locking prong extending outwardly;
a lower end defining a locking slot operable and configured to receive a respective locking prong of an adjacent distribution section.

4. The gravity feeder apparatus as in claim 3, wherein each locking slot defines:
a first void section extending longitudinally along a side wall of a respective distribution section and in communication with an open bottom of said respective distribution section; and
a second void section extending laterally from and in communication with the first void section;
wherein said first void section is operable to receive a respective locking prong and, upon opposing rotations of adjacent distribution sections, said second void section is operable to receive said respective locking prong.

5. The gravity feeder apparatus as in claim 1, further comprising a lid removably coupled to said rim, said lid being movable between a closed configuration that covers said open top to prevent access to said interior area of said hopper and an open configuration leaving said open top uncovered to allow access to said interior area of said hopper.

6. The gravity feeder apparatus as in claim 1, further comprising:
a pair of fasteners coupled to opposed sides of said rim;
a mooring member having an elongate and flexible construction and having a pair of ends coupled to said pair of mounting members, respectively, for hanging said hopper from a branch of a tree.

7. The gravity feeder apparatus as in claim 6, wherein said mooring member is one of a chain or a rope.

8. The gravity feeder apparatus as in claim 1, wherein said weight is a weighted ball.

9. The gravity feeder apparatus as in claim 2, wherein:
said upper portion of said lowermost section of said plurality of distribution sections has a diameter of about 6.5 inches;
said lower portion of said lowermost section of said plurality of distribution sections has a diameter of about 9.5 inches;
said lower portion has a diameter that is larger than a diameter of all other sections of said plurality of distribution section so that the granular feed is more widely distributed on a ground surface and resists becoming clogged.

10. The gravity feeder apparatus as in claim 9, wherein said weight has a diameter of about 4.5 inches for pushing the granular feed through an open bottom of the lowermost section of the plurality of distribution sections.

11. A gravity feeder apparatus for feeding granular feed to animals, comprising:
a hopper having a continuous side wall having a conical configuration, said continuous side wall having a rim at an upper end thereof defining an open top and having a mouth at a lower end that defines an open bottom;
wherein said continuous side wall defines an interior area for holding the granular feed inserted via said open top;
wherein said rim has a diameter that is larger than a diameter of said mouth such that said continuous side wall has a funnel-shaped configuration;
a plurality of distribution sections operably coupled to said mouth, each distribution section having a tubular configuration having an open top and an open bottom that allows the granular feed to pass therethrough; and
a spherical ball initially positioned atop the granular feed in said hopper, said spherical weight having a dimension and weight operable for pushing the granular feed downward from said hopper into said plurality of distribution sections, said spherical ball being movable by the force of gravity to pass through said mouth of said hopper and, after pushing all of the granular feed through said open bottom of a lowermost distribution section, passing itself through said open bottom of said lowermost distribution sections.

12. The gravity feeder apparatus as in claim 11, wherein said weighted ball has a diameter smaller than a diameter of said plurality of distribution sections such that said weighted ball is received into said plurality of distribution sections after the granular feed is pushed therethrough by said weighted ball.

13. The gravity feeder apparatus as in claim 11, wherein said rim has a diameter that is larger than a diameter of said mouth such that said continuous side wall has a conical configuration.

14. The gravity feeder apparatus as in claim 11, wherein said plurality of distribution sections includes:
an uppermost section coupled to said mouth of said hopper;
an lowermost section having an upper portion coupled to an upwardly adjacent distribution section and a lower portion having a diameter that is larger than a diameter of all other sections of said plurality of distribution section so that the granular feed is more widely distributed on a ground surface; and
a plurality of intermediate sections coupled between said uppermost section and said lowermost section.

15. The gravity feeder apparatus as in claim 11, wherein each distribution section of said plurality of distribution sections includes:
an upper end having a locking prong extending outwardly;
a lower end defining a locking slot operable and configured to receive a respective locking prong of an adjacent distribution section.

16. The gravity feeder apparatus as in claim 15, wherein each locking slot defines:
a first void section extending longitudinally along a side wall of a respective distribution section and in communication with an open bottom of said respective distribution section; and
a second void section extending laterally from and in communication with the first void section;
wherein said first void section is operable to receive a respective locking prong and, upon opposing rotations of adjacent distribution sections, said second void section is operable to receive said respective locking prong.

17. The gravity feeder apparatus as in claim 11, further comprising a mooring member having an elongate and flexible construction and having a pair of ends operably coupled to opposed sides of said rim, respectively, for hanging said hopper from a branch of a tree.

18. The gravity feeder apparatus as in claim 11, further comprising a support bar having opposed ends and a linear configuration, said support bar being positioned adjacent to and spanning across said open top defined by said rim.

19. The gravity feeder apparatus as in claim 12, wherein:
said upper portion of said lowermost section of said plurality of distribution sections has a diameter of about 6.5 inches;
said lower portion of said lowermost section of said plurality of distribution sections has a diameter of about 9.5 inches;
said lower portion has a diameter that is larger than a diameter of all other sections of said plurality of distribution section so that the granular feed is more widely distributed on a ground surface and resists becoming clogged.

20. The gravity feeder apparatus as in claim 19, wherein said weight has a diameter of about 4.5 inches for pushing the granular feed through an open bottom of the lowermost section of the plurality of distribution sections.
